(19) United States
(12) Patent Application Publication
(10) Pub. No.: US 2022/0235970 A1
(43) Pub. Date: Jul. 28, 2022

(54) Solar Heat Pump Water Heater

(71) Applicant: John Williams, Chesapeake, VA (US)

(72) Inventor: John Williams, Chesapeake, VA (US)

(21) Appl. No.: 17/657,789

(22) Filed: Apr. 4, 2022

Related U.S. Application Data
(63) Continuation-in-part of application No. 17/648,956, filed on Jan. 26, 2022.
(60) Provisional application No. 63/141,852, filed on Jan. 26, 2021.

(51) Int. Cl. F24H 15/429; F24H 4/04; H02J 3/38

(52) U.S. Cl. CPC F24H 15/429; H02J 2300/24; H02J 3/38; F24H 4/04

(57) ABSTRACT

A solar water heating pump system. A heat pump and a heat exchanger, connected to the heat pump, and creating heat that exchanges heat from the heat pump to change a temperature in a load, which is usually heated or cooled water. There is also a connection to grid power. A controller controls the heat pump and heat exchanger based on the grid power and detection of an amount of solar power that is available.

This application is a continuation in part of Ser. No. 17/648,956, filed Jan. 26, 2022, which claims priority from Provisional application No. 63/141,852, filed Jan. 26, 2021, the entire contents of which are herewith incorporated by reference.

### BACKGROUND

The solar water heating industry in the US has been decimated by the advent of ultra-high efficiency heat pump water heaters, and ultra-low-cost photovoltaic (PV) grid-tied solar panel systems. These technologies, when combined, make traditional solar water heating system via solar thermal collectors nearly obsolete. However, consumer interest in solar-only water heating systems still exists for smaller dedicated systems and off-grid solar water heating systems.

The PV powered water heating systems of the current art use either PV powered electric heating elements, or grid-tied PV to power conventional heat pump water heaters.

The present invention provides a new solution allowing a heat pump water heater to operate directly from solar panels while retaining the ability to use normal grid power, or both sources of power (solar and grid), when needed under applicable conditions.

For purposes of this document, a “heat pump” is defined in accordance with its common and generic meaning within the art, that is, a heating or cooling apparatus using a vapor compression refrigeration cycle. The heat pump typically has a refrigerant fluid, at least two heat exchangers with at least one serving as an evaporator (the cold side) and at least one serving as a condenser (the hot side). A heat pump further comprises a metering device, and an electrically powered compressor. The heat pump is configured to operate such that heat is “pumped” or moved using the vapor compression cycle from at least one heat changer acting as an evaporator and to at least one heat exchanger operating as a condenser. The operative effect of this is to provide a desired function of either heating, or cooling, as the desired case may be, at either or both of the heat exchangers.

A heat pump would not technically require, but would typically include, a reversing valve such as to have the ability to reverse the roles of the heat exchangers to provide one of either heating or cooling at either heat exchanger and the opposite at the other heat exchanger, and thus may also be used to accommodate a defrosting cycle. As such, as described herein, the term heating or heat refers to interfacing heat amounts with either coolant or water to be cooled, and hence refers generically to both the operations of heating and the operation of cooling.

The heat pump of the SHPWH is, in one embodiment, a “DC inverter” type powered by at least one inverter which may have at least one associated MPPT circuit which may be included as physical part of the heat pump or as a separate component of a heat pump. Said inverter has the ability to adjust its output power to control the speed of the compressor, and may have similar ability when powering a fan, pump or other component. Said inverter may vary such power output frequency, current or voltage according to the level of solar power available, for example, when the sun strength is strong, components powered by the inverter may operate at a higher frequency or voltage and therefore higher speed or capacity, likewise when sun strength is lower, such components may operate at a lower power and therefore lower speed or capacity. In the case of powering a heating element, voltage may be increased while current is reduced to conform with the resistance of the element. Said inverter may provide a fixed power to certain components while providing a variable power to other components. Said inverter may have the ability to accept power input from a source other than solar, for example, rectified from grid power, and mix or blend said grid power with available solar power, with a priority on using solar power. Said inverter may have the ability to import power from a grid source, but not have capability to export power to the grid. The inverter type compressor has the capability of variable speed according to the power applied. In a conventional inverter heat pump, power comes to the heat pump as AC power which is then converted to DC power at a desired power to operate any motors such as compressor or fan. In a typical heat pump, use of power is limited only by the controller in response to capacity requirements. In the current invention, capacity requirements still govern the maximum power needed. As described herein, the present invention operates, when possible, to limit the actual maximum power to what is available.

The fan of the heat pump or any pump or other electrical component may also be an inverter type and may be powered by the same or similar included inverter. When this document refers to a “heat pump”, it is doing so to describe the above heat pump as a component of the SHPWH system.

A heat pump may also be designed to work with a means of backup heat such as a resistance heating element. Such backup heating is not considered to be part of the heat pump but however may be a part of the solar heat pump water heating system.

### SUMMARY OF THE INVENTION

A heat pump is described that can operate in multiple modes. The heat pump, herein a SHPWH, receives variable power input, where electrical power comes from a solar power or other renewable source, and SHPWH may also have access to a supplemental normal power source. The SHPWH may at times use either or both power sources independently or together, with solar derived power as primary power and with normal power used as supplemental or replacement power. The SHPWH can be operated as solar-only, normal power only, or as a hybrid of both.

At any time where sufficient solar power is available, and the tank needs heat, the heat pump will start and ramp up to the lower of the appropriate speed as set, or to the highest speed that can be supported by the amount of solar power available. Any reduction of solar power will cause the SHPWH heat pump to reduce speed. Below a certain minimum solar power availability, the heat pump will stop.

### BRIEF DESCRIPTION OF THE DRAWINGS

The invention is described with reference to the drawings, in which:

FIG. 1 shows a heat pump with heat exchanger having a tank, where the heat exchanger is attached to or part of the wall of the tank;

FIG. 2 shows a heat pump with heat exchanger coil suspended in the tank;

FIG. 3 shows a water to water type heat exchanger;

FIG. 4 shows a heat pump separate from the tank with a refrigerant to water type heat exchanger coil that is on or part of the tank wall;

FIG. 5 shows the heat pump separate from the tank with a refrigerant to water type coil, with the heat exchanger coil suspended in the tank;

FIG. 6 shows a system where potable water is circulated between the tank and the heat pump and the tank includes a supplemental heater;

FIG. 7 shows the heated or cooled water in the tank used for space heating or cooling;

FIG. 8 shows a block diagram of the operation of the different parts of the system; and

FIG. 9 shows a flowchart of operation of the controller according to an embodiment.

### DETAILED DESCRIPTION

Embodiments describe a “solar heat pump water heating system” (SHPWH) aka “solar heat pump water heater” or may be referred to as the “system”. The “heat pump” is a part of the “system”. The system comprises the elements and functions of at least one “heat pump” further operatively connected to or comprising an inverter with MPPT functions, at least one water tank, a controller that operates and controls the heat pump water heating system, and may in some iterations contain a backup heating element. In various iterations, the inverter and/or MPPT circuitry may be incorporated within the SHPWH tank enclosure along with a tank and heat pump, located between the heat pump and the solar panels or other renewable source, or at the location of the solar panels or other renewable source.

The system is designed for use with variable, and/or at times multiple, sources of electrical power input, such as renewable energy, said renewable source may be combined with power from a normal power source, i.e., AC grid power (which may be simulated by a generator or other means) power. The renewable energy source of power will be described as solar but could of course also be wind, hydro or other renewable source.

The embodiment allows for the renewable source of electricity being variable, with limited or unpredictable strength or availability. The heat pump water heating system described herein is such that it accommodates variability, unpredictability, or lack of sufficiency of renewable energy power, such variability may be resolved in various ways including the option to reduce heat pump capacity to match the level of available power, switch to an alternate heating source, or, for normal power to be imported, if available, to be mixed with renewable sourced power to be used as a supplemental, or as a backup, source. Said normal power source, when used, may be used alongside of renewable power with the renewable source used first as a priority, or in replacement of renewable energy sourced power at desired times.

There are several aspects to the embodiments including variable input power management and variable performance and operation based on user defined programming.

The SHPWH receives variable power input, where electrical power comes from a solar power or other renewable source, and SHPWH may also have access to a supplemental normal power source. The SHPWH may at times use either or both power sources independently or together, with solar derived power as primary power and with normal power used as supplemental or replacement power. The SHPWH can be operated as solar-only, normal power only, or as a hybrid of both.

The system operates in three basic modes of operation, Solar Only Operation, Solar+Normal Power Hybrid Operation, and Normal-Power Only Operation as follows. Certain iterations may include one or more of these modes.

The system may include a sterilization function of heating to a certain temperature periodically and holding for a set time, or use of a UVC sterilization routine.

In a first embodiment, the SHPWH system power may be provided exclusively by solar power where the system is connected to solar PV panels. Water in a water tank is heated by the SHPWH system. Power is provided to heat the water tank when that water gets below a predetermined temperature set point. Assuming the water tank requires heat based on not meeting the predefined temperature set point, the SHPWH will operate the heat pump if enough solar power is available, and the speed/capacity of the SHPWH is controlled based upon the amount of available solar power and other internal factors.

The inventor recognizes however, that a heat pump requires a certain amount of power in order to reliably operate. Below that amount of power, the compressor cannot be properly driven and hence the heat pump cannot operate as designed.

At any time where sufficient solar power is available, and the tank needs heat, the heat pump will start and ramp up to the lower of the appropriate speed as set, or to the highest speed that can be supported by the amount of solar power available. Any reduction of solar power will cause the SHPWH heat pump to reduce speed. Below the certain minimum solar power availability, the heat pump will stop operating.

In one embodiment, the heat pump speed is best-effort. In this mode, the heat pump will operate as fast as it needs to, subject to the amount of available solar power, until the point at which the tank setpoint temperature has been reached. When solar power falls below an allowed minimum, the SHPWH heat pump will stop. If the tank continues to indicate a need for heat, the SHPWH will periodically check for available power and attempt to restart.

In certain configurations of this embodiment, the functions of the above are employed. However, backup heating (heating element installed in the tank) function may be allowed by the controller. in this case, if solar power is too low to reliably operate the SHPWH heat pump, the controller may switch any available solar derived power to a resistance water heating element installed in the water tank and water heating may be performed by the resistance element. This is because a resistance element typically does not have the same kind of minimum power, any power of any amount applied to a resistance element will typically cause water heating. During such element operation, the controller may monitor the power usage, and if or when the controller decides that enough power is available to again operate the heat pump, the controller can stop the element and start the heat pump.

In such a case where the heat pump is off due to power requirements and the tank needs heat, the available solar power is routed to the resistance element. This configuration may include a voltage limiting circuit applied to the solar power feeding the heating element.

The controller may also have the ability to manage the power sent to the resistance heating element while the heat pump is operating, such that the heating element receives any excess power, that is, power available from solar that is not being consumed by the heat pump. Thus, in this configuration, any time that the 1) the tank needs heat, and 2) the system has solar power available in excess of what is needed to run the heat pump, excess power may be allowed to flow to the resistance heating element. Any reduction in available solar derived power would first be applied to reducing power to the element before heat pump speed would be reduced.

In a Solar+Normal Power Hybrid Operation embodiment, the SHPWH system connects to both solar power and normal grid power. In this case, the system has the ability to use all of the available solar power as primary power. If more power is needed to run the heat pump at a desired speed than is available from solar, the inverter circuit may be allowed to import certain amounts of normal power to be blended with the solar derived power such that the heat pump may be able to run at a desired speed. In some configurations, even when normal power is available, the system may be configured to operate only on solar-only during certain time periods or conditions. As an example, normal power may be denied during the day and allowed to operate only at night, or at set times or conditions. The control parameters may be defined to allow normal power only at scheduled times, or under certain conditions, or when no solar is available, etc. In the case where normal power is being used, the resistance element use is optional based on controller configuration. For example, certain solar+normal power configurations may not use the backup element at all.

In other configurations, the controller may allow the heating element to operate according to applied configuration parameters that are set in the controller. Many of these configuration parameters are described herein.

In embodiments, the heating element can operate only, if needed, during a weekly or other schedule anti-legionella process, or during periods when the demand exceeds the capacity of the heat pump, or could allow a user-triggered “turbo” or special mode that invokes an emergency heating call in response to high demand or expected demand in which case the SHPWH may operate the heat pump and resistance element simultaneously according to the controller settings. Other configurations may, for example, allow normal power to be applied only based on certain conditions such as the tank not being at a certain temperature at a certain time.

The system may be configured to use normal power only and retain any applicable controller functions.

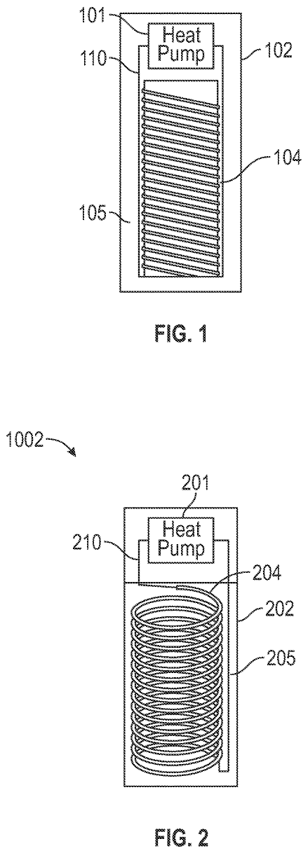

In a primary embodiment, the SHPWH system heat pump is operatively coupled with a storage water heater tank where the heat pump may be enclosed in an all-in-one configuration such that it is within the same enclosure as the tank, see FIG. 1. In this configuration of FIG. 1, the heat pump 101 has its refrigerant line 110 connected to a refrigerant-to-water heat exchanger 104 attached to or made as part of the wall 105 of a storage water heater tank 102.

Alternatively, shown in FIG. 2, the SHPWH system heat pump 201 is connected directly to a storage water heater tank where the heat pump may be enclosed in an all-in-one configuration. In this configuration, the heat pump 201 is within the same enclosure as the tank 202. In this embodiment, the heat pump 201 is connected is to a refrigerant-to-water heat exchange coil 205 that is suspended in the tank 202.

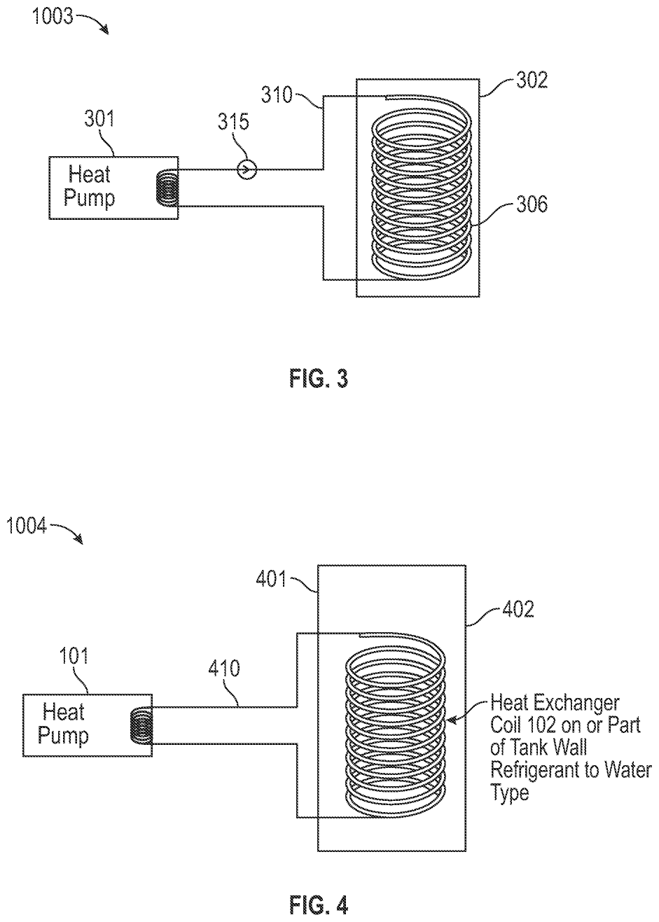

In other configurations the heat pump may be “water-split” as shown in FIG. 3, where heat pump 301 has its water line 310 connected to a heat exchanger coil 306 suspended in tank 302. In this example, circulated water is used to carry heat between the heat pump 303 and a water-to-water heat exchanger in tank 302, assisted by a circulator pump 315. It should be understood that in this example, the heat exchanger may instead be attached to or made as part of the tank wall rather than being suspended in the tank. Also it should be understood that anywhere in this specification where we refer to water, in the context of using it as a heat transfer fluid, rather than potable water heated in a tank, or when water is referred to in the context of as “water-to-water” heat exchanger, that the “water” on the heat transfer side may also include anti-freeze agents, surfactants, or corrosion inhibitors in an aqueous mixture.

In other configurations for example as shown in FIG. 4, where the heat pump may be “refrigeration-split” and connected to a refrigerant-to-water heat exchanger in tank 402. In this case, the heat pump 401 may have its refrigerant lines 410 connected to a heat exchanger attached to or made as part of the wall of a storage water heater tank 402.

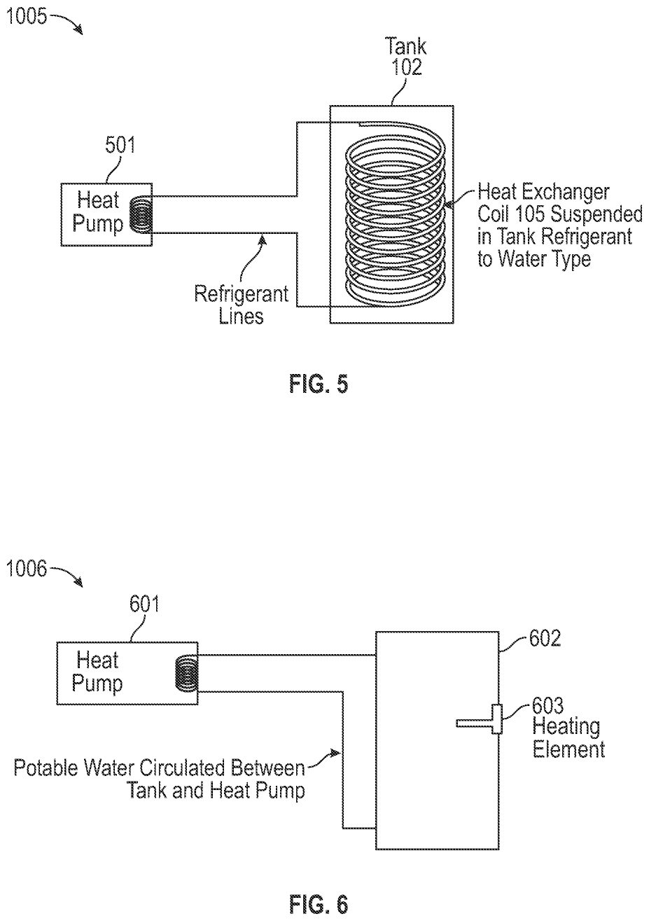

FIG. 5 shows an embodiment where the heat pump is “refrigeration-split” and connected to a refrigerant-to-water heat exchanger in tank 102. In this case, heat pump 101 may be connected to a heat exchanger suspended in the tank or attached to or made as part of a tank wall storage water heater tank 102.

FIG. 6 shows an embodiment where the heat pump may be “split” and there is no heat exchanger in tank 602. In this case, the potable water is circulated from tank 602 to heat pump 601 and returned back to tank 602.

FIG. 6 also shows an optional heating element 603 installed in tank 602. It should be noted that optional heating element 603 shown in FIG. 6 can be installed in any of the above examples of FIGS. 1-6. Further, more than one element 603 could be installed in any of tanks in any of FIGS. 1-6.

It should be noted that this document refers to the SHPWH as being a domestic water heating system. Since the heat pump may be equipped with a reversing valve, the “hot” side can easily become the “cold” side, therefore the SHPWH could just as easily be set up to either heat or cool the water in the tank rather than heat it. For example, any of FIGS. 3-6 could just as easily be used in a hydronic heating or cooling system.

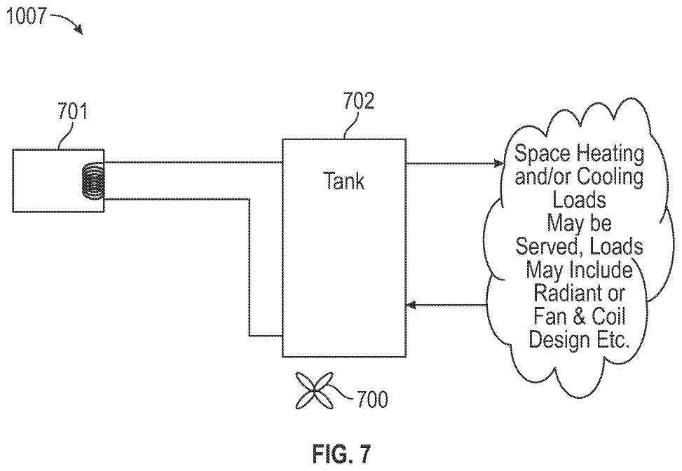

For example, FIG. 7 shows one of many possible embodiments, where the system could be used for space heating and/or cooling purposes. In this embodiment, water from the tank is circulated into a coil, and air blows across the coil so it can perform space heating and/or cooling depending on the water temperature. Likewise, water from the tank can be circulated into a radiant system for heating or cooling.

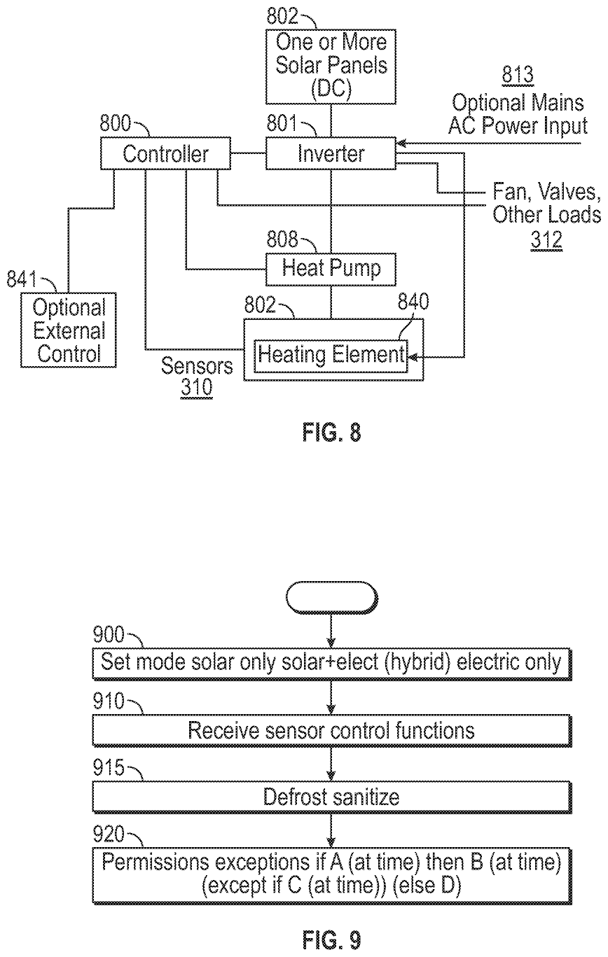

FIG. 8 shows a logical topology example of the heat pump system major components in an embodiment. One or more solar panels 802 have their output (DC) connected to an inverter 801, which supplies power to the heat pump 808, to controller 800, and to other loads 812 such as valves, fans, or other loads 312. In addition, there can be an optional AC power input 813, such that supplemental power from grid or normal can be mixed with or replace solar derived power when solar power insufficient or absent. The heat pump 808 operates to heat (or cool) the water in tank 802. There can also be a number of sensors 830, for example, sensing the temperature of water in the tank 802. In addition, the inverter can operate a heating element 840, which can be a resistive element, of the type used and described herein.

The system controller 800 may operate according to the flowchart of FIG. 9. The controller 800 communicates with the heat pump, including an inverter powering the heat pump, further including at least one MPPT control circuit. The controller 800 may set a mode of operation as in 900, including a mode such that solar power may be used as an exclusive power source. It may operate in a hybrid configuration where solar is the primary power input and where normal power may be used to compensate for an absence or shortage of solar power. The controller can also operate in a normal power only mode. The controller may thus select between available operating modes such as for example solar power-only, solar+normal power, or normal power only, according to the options presented and how configured.

At 910, the controller 800 also communicates with various sensors of the heat pump system and performs functions such as on/off of the system. It carries out compressor speed control, establishing a set point(s), deciding when or under what conditions a backup heating element is allowed to operate, and allow/deny normal power, etc. as mentioned previously.

The controller 800 may at times initiate a defrost cycle at 915, whereby the system is temporarily reversed by a reversing valve.

In any operating mode, there may be 920 shows the certain permissives and/or exceptions that may be defined and used. As an example, settings may define the operation as solar-only but also create an exception that says, “solar only, except if tank is below 120F temp at 6 am, then allow normal power until 120F temp is reached”. Or “solar only, except if tank is below 120F temp at 6 am, then allow normal power until 7 am”. The possible range of permissives and/or exceptions are not limited herein and may be such as a person skilled in the art may decide to implement. The permissive zone exceptions can be of the form, if general, if A (at time, then B (at time (except if C (at time)) or other forms of control logic.

The controller may have 1, 2 or more than 2 set points such that for example a user may define different setpoints based on times of day, day of week, or according to power source, according to usage, or according to other settings.

For example, the tank may have a 120F setpoint target when powered by normal power by may have a 150F setpoint target when operating on solar power only. This can be set in the form, if (solar power is available) then (set the set point to 150 F) otherwise set the set point to 120 F.

Additional exceptions or permissives may be layered on top of the above mentioned, for example, as compound set of exceptions might indicate “solar only, but, if tank is below 120F temp at 6 am, then allow normal power until 120F temp is reached, or until 7 am, whichever first occurs, except, don't do any of this on Saturday or Sunday”.

Saturday or Sunday or any weekday may have their own set of instructions.

Other configurations may be used with the controller at 915 to change this to a sanitize operation. For example, this may cause the system tank temperature to reach a certain temperature and hold it for a certain period of time. The system can be configured to do this on a certain schedule for purposes of anti-legionella or other purposes. The controller may also manage a UVC lighting function within the tank for tank sterilization.

The controller may also be configured to manage the power sent to the resistance heating element. For example, one embodiment describes a solar-only mode such that the element only receives power under certain conditions including but not limited to using excess power, that is, solar power available that is not being consumed by the heat pump. Thus, any time that the 1) the tank needs heat, and 2) the heat pump has solar power available in excess of what is needed to operate the heat pump at maximum capacity, excess power may go to the resistance element.

The controller may also be configured to stop the heat pump when solar power falls to a level below a pre-defined level of watts or voltage, and send solar derived power to a backup element and monitor power levels of the element to ascertain a level of solar power availability, and revert back to heat pump operation when conditions permit.

Likewise the controller may, under certain conditions, invoke grid power backup to operate the heat pump, or the heating element, or both, with or without solar availability. The controller is configured to have a wide range of programmable functions that allow the factory, the user, or the installer, to determine the permissives, exceptions, schedule, priority, set points, and operating sequences, etc. of the system.

Below is a non-limiting example of a basic system according to an embodiment. All of these operations can be carried out by the controller.
use default system set to always use all available solar power, and allow grid power use only under certain user-defined conditions, for example user can select to allow normal grid power use as follows:

1. Never, or

2. anytime heat pump needs more capacity than solar can provide, or

3. when heat pump needs more capacity than solar can provide but only when certain other permissive or exception conditions are met, examples as follows:
only during user-predefined times (hours, days of week etc.,)
only during user-predefined conditions (example, tank temperature, or tank temperature during a certain time period
only during a scheduled anti-legionella operation

4. system has multiple user definable set point targets, one for when solar-only is being used, and one for when grid power is being used, additional set points may be based on time of day, day of week, are available

5. control the use of the backup heating element as follows
on solar-only & without grid-power: when solar power is not enough to operate heat pump at its lowest speed, stop compressor and switch available solar-derived power to element, During such element operation, system will monitor power use of the element to see if solar power rises back to the point when compressor can be re-started and switch power back to compressor when able
with grid power is being used: element is used only during user-defined times or conditions
for example, subject to # 6,7 below

6.—user defined option to enable grid connection, and if needed, the element, for anti-legionella operation even if system is set to never use grid power
anti-legionella function should be able to monitor and record past x days of tank temperatures, and be able to suspend or delay its operation if anti-legionella temp/hold time requirements have been met during prior x days

In another embodiment, WiFi can be used to send or log performance data or as a remote control.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A heating system, comprising:
a heat pump;
at least one inverter;
a heat exchanger, connected to the heat pump, that exchanges heat with the heat pump to change a temperature in a load;
a resistance water heater;
a connection to a solar power; and
a controller that detects an amount of available solar power,
and where the controller operates in a first mode where the heat pump will operate subject to an available amount of solar power, until a temperature setpoint of the load is reached,
and the controller operates to detect when solar power falls below an allowed minimum which represents a value where the solar power is too low to reliably operate the heat pump, the controller switches available solar derived power to the resistance water heating element.

2. The system as in claim 1, where the controller detects when the amount of solar power exceeds an amount that the heat pump is able to use,
and sends additional power to the resistance heating element while the heat pump is operating.

3. The system as in claim 1, further comprising a connection to grid power, used supplementally to the solar power.

4. The system as in claim 3, wherein the system operates to use available solar power as primary power, and if more power is needed to run the heat pump at a desired speed than is available from solar, the grid power is blended with the solar power to allow the heat pump to run at a desired speed.

5. The system as in claim 3, further comprising the controller accepting permissives and exceptions that set a way that the system operates, using both the solar power and the grid power.

6. The system as in claim 5, wherein the permissives and exceptions change a mode of operation from solar only, to solar only with an exception that is set as part of the permissives and exceptions.

7. The system as in claim 6, wherein the exception is in a format detecting if the load temperature is below x temperature at y time, then allow grid power until z.

8. The system as in claim 7, where z is one of a time or a temperature.

9. The system as in claim 1, where the load is water, that is heated by the heat pump.

10. A load heating system, comprising:
a heat pump;
at least one inverter;
a heat exchanger, connected to the heat pump, and creating heat that exchanges heat from the heat pump to change a temperature in a load;
a connection to grid power; and
a controller that controls the heat pump and heat exchanger based on the grid power and detection of an amount of solar power that is available, the controller normally operating to use all available solar power, and to allow using the grid power use only under certain user-defined conditions, including a selected one of:
Never, or
anytime heat pump needs more capacity than solar can provide, or
when the heat pump needs more capacity than solar can provide but only when another condition is met,
where the another condition is one or more of
only during user-predefined times
only during user-predefined conditions; or
only during a cleaning operation.

11. The system as in claim 10, where the system has multiple user definable set point targets, a first set point target for when solar-only is being used, another set point target for when grid power is being used, and based on time of day, day of week, are available.

12. The system as in claim 10, further comprising a resistive heating element, and a control for the resistive heating element to control use of the resistive heating element when on solar-only and without grid-power: when solar power is not enough to operate heat pump at its lowest speed, to stop a compressor and switch available solar-derived power to the resistive heating element.

13. The system as in claim 10, further comprising a resistive heating element, and the controller carries out a sterilization operation using the resistive heating element, and to enable grid connection during the sterilization operation, even if the system is set to never use grid power.

14. The system as in claim 13, wherein the controller to monitor and record a past x days of tank temperatures, and determines if temp/hold time requirements have been met during prior x days and stops a current sterilization operation if so.

15. The system as in claim 10, where the times are one of hours and/or days of week.

16. A heating system, comprising:
a heat pump;
at least one inverter;
a heat exchanger, connected to the heat pump, and creating heat that exchanges heat from the heat pump to change a temperature in a load;
a connection to a solar power; and
a controller that detects an amount of available solar power,
and where the controller operates in a first mode where the heat pump adjusts its speed and operates at its highest capacity possible based on the amount of available solar power until a temperature setpoint of the load is reached.

17. The system as in claim 16, further comprising a connection to grid power, where the controller controls the grid power to be used supplementally to the available solar power, and the controller causes solar to be used as primary power and where extra power needed by the heat pump beyond that available from solar power is supplied by grid power, thereby used supplementally mixing grid power in with the available solar power,

18. The system of claim 3 where the system is configured so as to deny inverted solar power to be exported to the grid.

19. The system of claim 3 where the system is configured so as to allow inverted solar power to be exported to the grid.

20. The system as in claim 1 where the system monitors the use of power by the element and when solar power increases to a sufficient point to operate the compressor, switches power back to the compressor and restarts operation of the compressor.
